(19) United States
(12) Patent Application Publication
(10) Pub. No.: US 2002/0181135 A1
(43) Pub. Date: Dec. 5, 2002

(54) Current bias circuit used in magnetic-signal detection head

(75) Inventors: Toru Takeuchi, Tokyo (JP); Takehiko Umeyama, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 09/983,120

(22) Filed: Oct. 23, 2001

(30) Foreign Application Priority Data
Jun. 1, 2001 (JP) 2001-167170

(51) Int. Cl. G11B 5/03

(52) U.S. Cl. 360/66

(57) ABSTRACT

The current bias circuit used in a magnetic-signal detection head includes an amplifier that generates a bias current control voltage based on a reference current which regulates the bias current. A bias current I supplied to a MR head is controlled based on this control voltage. The current bias circuit is also provided with a control voltage changing unit that includes a current source and a switch. This control voltage changing unit changes a value of the control voltage without changing the reference current.

### FIELD OF THE INVENTION

The present invention relates to a current bias circuit used in a magnetic-signal detection head applied to a magnetic memories, such as a hard disk drives (“HDD”) or floppy disk drives (“FDD”). More specifically, this invention relates to a current bias circuit that prevents flow of unnecessarily large transient current to the head.

### BACKGROUND OF THE INVENTION

Conventionally, the circuit shown in FIG. 13 is used as a current bias circuit for a magnetic-signal detection head (“MR head”) of the HDD. This current bias circuit includes a current amplifying amplifier constituted of the amplifier AP1, current source CS1, resistances R1, R2, and the variable current source CS2. This current amplifying amplifier outputs head bias current Is obtained by multiplying a reference current Iref from the current source CS1 by (R1/R2), to thereby bias the MR head H by this bias current Is.

The amplifier AP1 compares the reference current Iref and the bias current Is and outputs a voltage Vo1 corresponding to the difference. However, since a high frequency noise is contained in this reference current Iref, high frequency noise is also contained in the output voltage Vo1 of the amplifier AP1. Therefore, the low-pass filter LPF1 outputs a voltage Vo1′ obtained by removing the high frequency noise from the output voltage Vo1 to thereby drive the variable current source CS2. The output of the MR head H biased by the output current Is of the current source CS2 is amplified by a read amplifier Ramp and output to the next stage.

The amplifier AP2 compares a midpoint potential of the MR head H obtained by a pair of resistances Rg connected in parallel to the MR head H with the GND potential, and outputs a voltage Vo2 corresponding to the difference between these potentials. To the output of this amplifier AP2 is connected a low-pass filter LPF2 for cutting the high frequency noise contained in the voltage Vo2. The output voltage Vo2′ of this low-pass filter LPF2 drives the variable current source CS3, and hence the midpoint potential of the MR head H is maintained to the GND potential.

A switch Sw11 provided between the current source CS2 and one end of the MR head H, and a switch Sw12 put between the other end of the MR head H and the current source CS3 are turned OFF at the time of write or at the time of electric power saving when it is necessary to cut the bias current Is. However, when the bias current Is is cut, a voltage drop by means of the resistance R2 is lost, and hence high voltage is input to the amplifier AP1 via this resistance R2. As a result, the output voltage Vo1 of this amplifier AP1 is scaled out.

Therefore, when the switches Sw11 and Sw12 are turned OFF, the amplifier Ap1 is also turned OFF by means of a control logic, to thereby prevent a change in the output voltage Vo1. When the switches Sw11 and Sw12 are turned OFF, the output voltage Vo2 of the amplifier AP2 also changes. Therefore, when the switches Sw11 and Sw12 are turned OFF, the amplifier AP2 is also turned OFF by the control logic, to thereby prevent a change in the output voltage Vo2. As a result, the output voltage Vo1′ of the low-pass filter LPF1 and the output voltage Vo2′ of the low-pass filter LPF2 can be maintained to substantially the same value as that of when the current Is being flowing, even when the bias current Is is cut.

On the other hand, when the bias current Is is made to be changed, the value of the reference current Iref is also changed. At this time, with a change of the output voltage Vo1 of the amplifier AP1, feedback is provided so that the current value of the current source CS2 is returned to the original value. Therefore, if the time constant of the low-pass filter LPF1 is kept large, it takes time until the output voltage Vo1′ becomes a desired value, due to a response delay of the low-pass filter LPF1. Also on the side of the amplifier AP2, due to the response delay attributable to the time constant of the low-pass filter LPF2, it takes time until the output voltage Vo2′ becomes a desired value.

In order to solve such problems, while a certain period of time has passed since when the value of the reference current Iref is changed, the time constants of the low-pass filters LPF1, LPF2 are made small, to thereby reduce time until the values of these output voltages Vo1′, Vo2′ are fixed.

Generally, in the HDD, magnetic heads are present in plural numbers. FIG. 14 shows a current bias circuit applied to such magnetic heads. In this current bias circuit, at the time of selecting a MR head H1, switches Sw11 to Sw15 are turned ON. At the time of selecting a MR head H2 instead of the MR head H1, switches Sw11 to Sw15 are turned OFF and switches Sw21 to Sw25 are turned ON. At this time, since the output impedance of the variable current source CS2 has a finite value, when the resistance values Rh1, Rh2 of the MR heads H1, H2 are different, the current value of the current source CS2 changes immediately after switching these heads. In order to suppress this change in the current value, the time constants of the low-pass filters LPF1 and LPF2 are made small for a certain period of time immediately after the switching thereof, so that the bias current Is can be promptly settled to a predetermined value, at the time of switching the heads.

As described above, at the time of cutting the bias current Is, the operation of the amplifier AP1 is turned OFF by the control logic so as to maintain the output voltage Vo1′ of the low-pass filter LPF1 to a value before cut of the bias current Is. During the bias current Is being cut, if it is assumed that the value of the above voltage Vo1′ is not changed at all, the value of the current Is immediately after reset of the bias current Is becomes the same as the value before cut.

However, the value of the output voltage Vo1′ may be shifted during the bias current Is being cut, due to an influence of a leak current, a temperature drift or the like in the amplifier AP1. In this case, the value of the bias current Is becomes different immediately after reset and before the cut.

The above described shifted output voltage Vo1′ tends to return to the value before the shift, with the operation of resetting the bias current Is (ON operation of the switches Sw1, Sw2). However, if it takes long time to reset, a problem occurs in that the time required until the bias current Is returns to the value before the cut becomes long. However, this problem can be overcome by decreasing the time constant of the low-pass filter LPF1 to thereby lose no time in giving a response of the voltage Vo1′ with respect to the reset change of the voltage Vo1 (the same thing applies to the output voltage Vo2′ of the low-pass filter LPF2).

There may be a case where the value of the bias current Is immediately after reset increases or decreases with respect to the value before the cut, due to the shift direction of the voltage Vo1′, a circuit construction or the like. In the former case, following problems occur. That is to say, the MR head has recently been improved steadily in the detection sensitivity. This is because with an increase of recording density, it is required to be able to detect a small magnetic-signal. Therefore, flowing a large bias current to the MR head even in a very short period of time may cause deterioration or breakage in the MR head.

On the other hand, at the time of switching the heads or switching the set value of the bias current, a large current may flow temporarily to the MR head, and this may cause damage in the MR head. Therefore, it becomes necessary to have a protection circuit for preventing a large current having a possibility of deteriorating or breaking the MR head from flowing to the head.

### SUMMARY OF THE INVENTION

It is an object of the present invention to obtain a current bias circuit that can prevent a large electric current from flowing temporarily to the MR head, at the time of resetting the bias current, at the time of switching the heads, or at the time of switching the set value of the bias current.

The current bias circuit according to the present invention includes an amplifier that generates a bias current control voltage based on a reference current which regulates the bias current. A bias current I supplied to a magnetic-signal detection head is controlled based on this control voltage. The current bias circuit is also provided with a control voltage changing unit that includes a current source and a switch. This control voltage changing unit changes a value of the control voltage without changing the reference current.

Other objects and features of this invention will become apparent from the following description with reference to the accompanying drawings.

### BRIEF DESCRIPTION OF THE DRAWINGS

FIG. 1 is a circuit diagram showing a first embodiment of the current bias circuit according to the present invention;

FIG. 2 is a circuit diagram showing a current bias circuit in the first embodiment applied to a plurality of heads;

FIG. 3 is a circuit diagram showing one example of a low-pass filter;

FIG. 4 is a time chart exemplifying operating waveforms when the bias current is turned ON and OFF;

FIG. 5 is a time chart exemplifying operating waveforms when a head is switched over;

FIG. 6 is a circuit diagram showing a second embodiment of the current bias circuit according to the present invention;

FIG. 7 is a circuit diagram showing a configuration example of a conductance amplifier;

FIG. 8 is a circuit diagram showing the construction of an inverting amplifier;

FIG. 9 is a circuit diagram showing the construction of a low-pass filter including the conductance amplifier and the inverting amplifier;

FIG. 10 is a circuit diagram of a current bias circuit using a read amplifier of a single-end input type;

FIG. 11 is a circuit diagram showing a third embodiment of the current bias circuit according to the present invention;

FIG. 12 is a circuit diagram showing a fourth embodiment of the current bias circuit according to the present invention;

FIG. 13 is a circuit diagram showing one example of a conventional current bias circuit; and

FIG. 14 is a circuit diagram showing another example of a conventional current bias circuit.

### DESCRIPTION OF THE PREFERRED EMBODIMENTS

Embodiments of the current bias circuit of the magnetic-signal detection head according to the present invention will now be described with reference to the accompanying drawings.

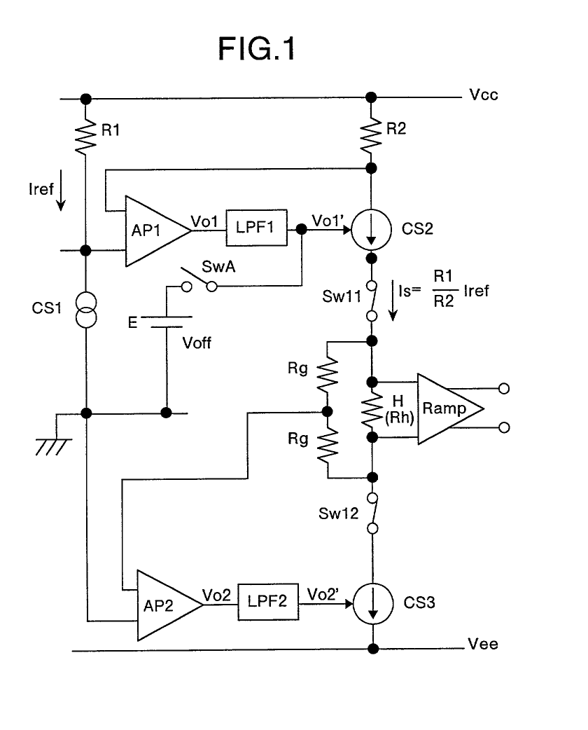

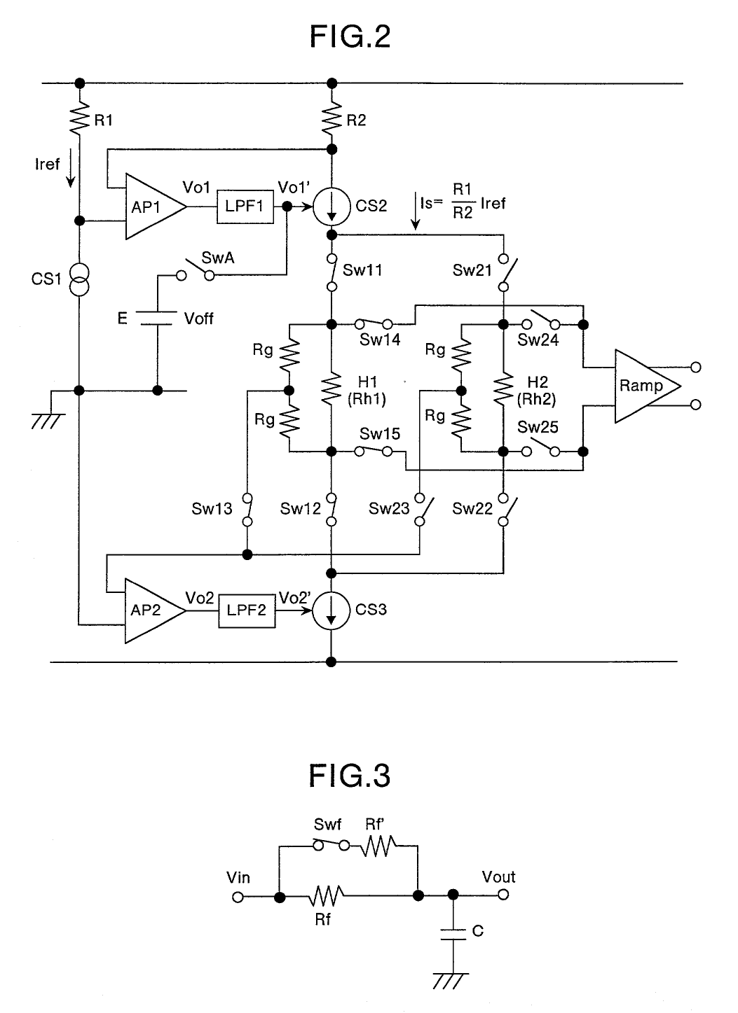

FIG. 1 and FIG. 2 show the current bias circuit of the magnetic-signal detection head according to the first embodiment of the present invention. The current bias circuit in FIG. 1 is applied to a single head, and the current bias circuit in FIG. 2 is applied to a plurality of (two in this example) heads.

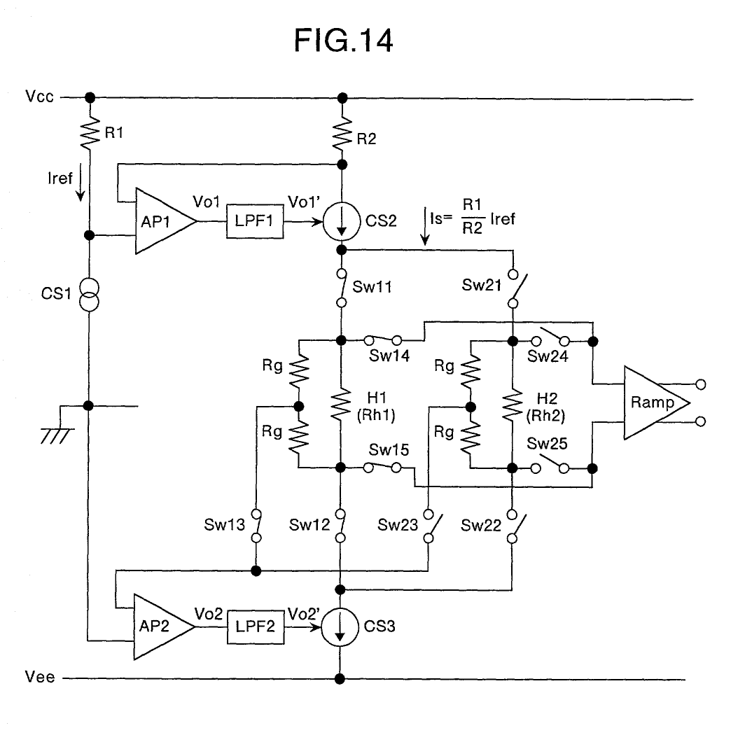

The current bias circuit shown in FIG. 1 and FIG. 2 has a construction common to the current bias circuit shown in FIG. 13 and FIG. 14, respectively, except of comprising a switch SwA and a voltage source E. Therefore, description of the common construction and the operation thereof is omitted. The above switch SwA and the voltage source E are put between the output of the low-pass filter LPF1 and the ground in series. The low-pass filters LPF1 and LPF2 have, as shown in FIG. 3, a construction comprising a resistance Rf, a capacitor C and a resistance Rf′ connected in parallel to the resistance Rf via a switch Swf, and can change the time constant by opening and closing operation of the switch Swf.

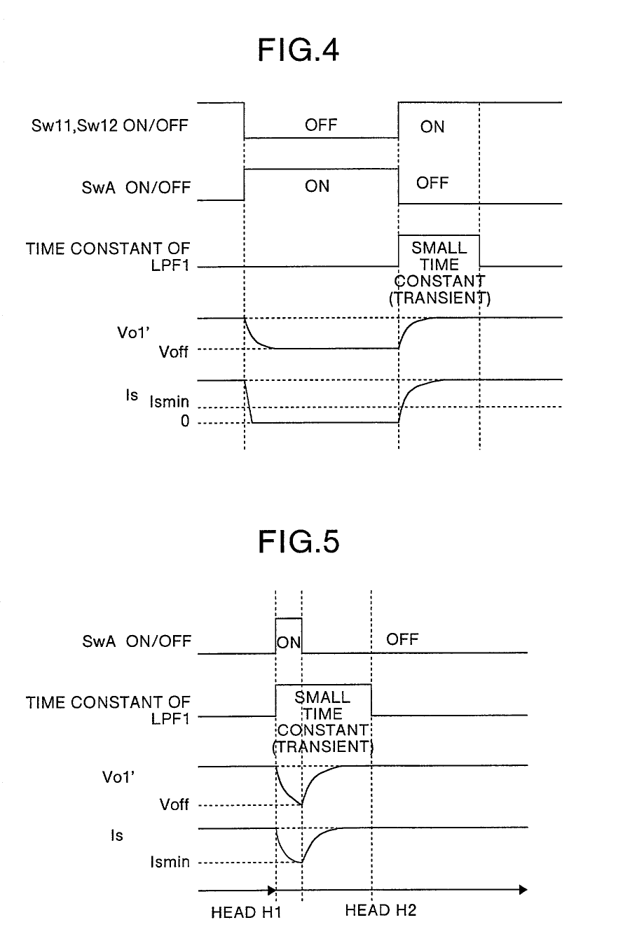

The switch SwA shown in FIG. 1 and FIG. 2 are maintained in the ON state continuously, while the switches Sw11 and Sw12 are turned OFF, as shown in FIG. 4. As described above, when the switches Sw11 and Sw12 are turned OFF, the amplifier Ap1 is also turned OFF by the control logic, to thereby maintain the output voltage Vo1′ of the low-pass filter LPF1 in substantially the same value as that of when the bias current Is being flowing. In this state, when the switch SwA is turned ON, the voltage source E is connected to the output of the low-pass filter LPF1. As a result, the output voltage Vo1′ of the low-pass filter LPF1 is changed forcibly to the output voltage Voff of the voltage source E.

The output voltage Voff of the voltage source E is set the value of the output voltage Vo1′ of the low-pass filter LPF1 when Is is sufficiently lower than that in the steady states where the switches Sw11 and Sw12 are turned ON, as shown in FIG. 4. The value of the bias current Is in the state that the switches Sw11 and Sw12 are turned ON depends on the output voltage Vo1′ of the low-pass filter LPF1 (in the example shown in FIG. 1 and FIG. 2, the bias current Is increases with an increase of the output voltage Vo1′). Therefore, at the time when the switches Sw11 and Sw12 are turned ON in order to reset the bias current Is, as shown in FIG. 4, a bias current Ismin corresponding to the voltage Voff (sufficiently small compared to the value of the bias current Is before cut) flows to the MR head.

Thereafter, the output voltage Vo1′ of the low-pass filter LPF1 tends to return to the value before the bias current Is is cut. At that time, the switch Swf for changing the time constant shown in FIG. 3 is turned ON, so as to decrease the time constant of the low-pass filter LPF1. In FIG. 4(c), there is shown a transient based on the time constant when this switch Swf is turned ON. The bias current Is promptly returns to the desired value before the bias cut, in the transient based on such a small time constant. After completion of resetting the bias current Is, the switch Swf for changing the time constant is turned OFF.

As described above, according to the first embodiment, the output voltage Vo1′ of the low-pass filter LPF1 during the bias current Is being cut is changed forcibly to the output voltage Voff of the voltage source E, and hence during the cut, the above output voltage Vo1′ does not exceed the value before the bias cut. Therefore, there is no possibility that an excessive current flows to the MR head (in the circuit of FIG. 2, the MR head H1 or Rh1), immediately after reset of the bias current Is. As a result, deterioration and breakage of the head due to this excessive current can be reliably avoided. The time constant of the low-pass filter LPF2 is decreased with the same timing as that of the time constant of the low-pass filter LPF1.

The switch SwA is turned ON also at the time of selecting the MR head H2 instead of the MR head H1, in the current bias circuit in FIG. 2. As already described with reference to FIG. 14, the output impedance of the variable current source CS2 has a finite value. Therefore, when the values of resistances Rh1 and Rh2 of the MR heads H1 and H2 are different, the current value of the current source CS2 changes immediately after switching these heads. This means that immediately after switching from the MR head H1 to the MR head H2, there is a possibility that an excessive current may flow to this MR head H2.

Therefore, as shown in FIG. 5, the switch SwA is turned ON for a predetermined period of time at the time of switching, for example, from the MR head H1 to the MR head H2. At the time of switching the heads, the time constant of the low-pass filter LPF1 is decreased for a certain period of time immediately after the switching thereof, so that the bias current Is can be promptly settled to a predetermined value. The above switch SwA is turned ON at the initial stage of the transient based on this decreased time constant.

When the switch SwA is turned ON, as shown in FIG. 5, the output voltage Vo1′ of the low-pass filter LPF1 is changed to the voltage Voff or so as to approach the voltage Voff. Therefore, the bias current Is approaches the value Ismin corresponding to this voltage Voff. When the switch SwA is again turned OFF, the bias current Is changes to a desired value in the remaining transient.

As described above, according to the first embodiment, the output voltage Vo1′ of the low-pass filter LPF1 is changed forcibly to the output voltage Voff of the voltage source E for a certain period of time at the time of switching the heads. Hence, there is no possibility that an excessive bias Is flows to the selected head (in the above example, the MR head H2), immediately after switching the heads. As a result, deterioration and breakage of the head due to this excessive current can be reliably avoided.

Also at the time of switching the set value of the bias current, a large current may flow temporarily to the MR head, and this may cause damage in the MR head. Therefore, also at the time of changing the value of the reference current Iref to change the bias current Is, the switch SwA is turned ON at the initial stage of the above transient, as at the time of switching the heads.

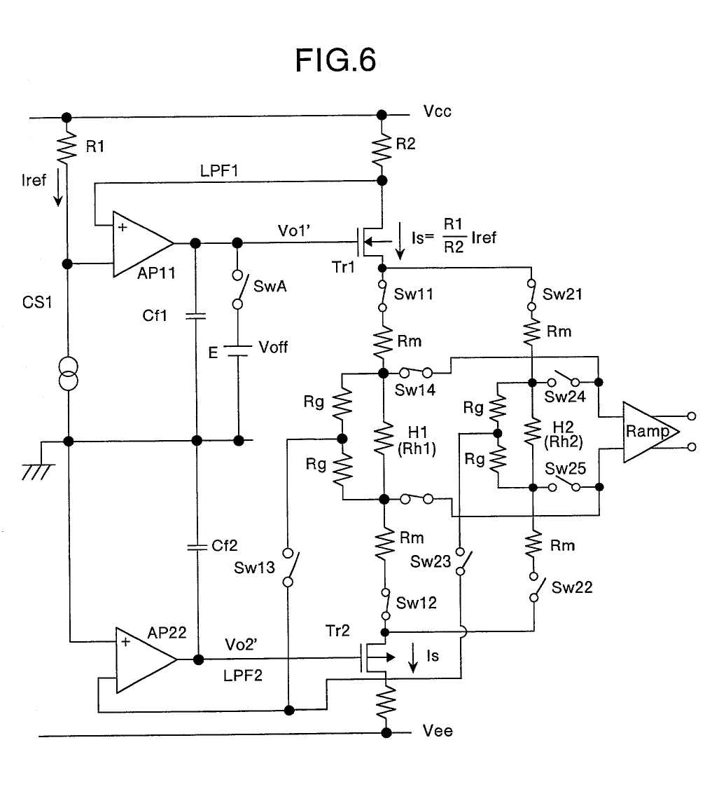

FIG. 6 shows a current bias circuit according to the second embodiment. In this current bias circuit, conductance amplifiers AP11 and AP22 are used instead of the amplifier Ap1 and AP2 shown in FIG. 1, and filter capacitors Cf1 and Cf2 are respectively put between the output of these conductance amplifiers AP11 and AP22 and the ground line, with a resistance Rm (Rm>Rh) being connected in series, respectively, to one end and to the other end of the MR head H.

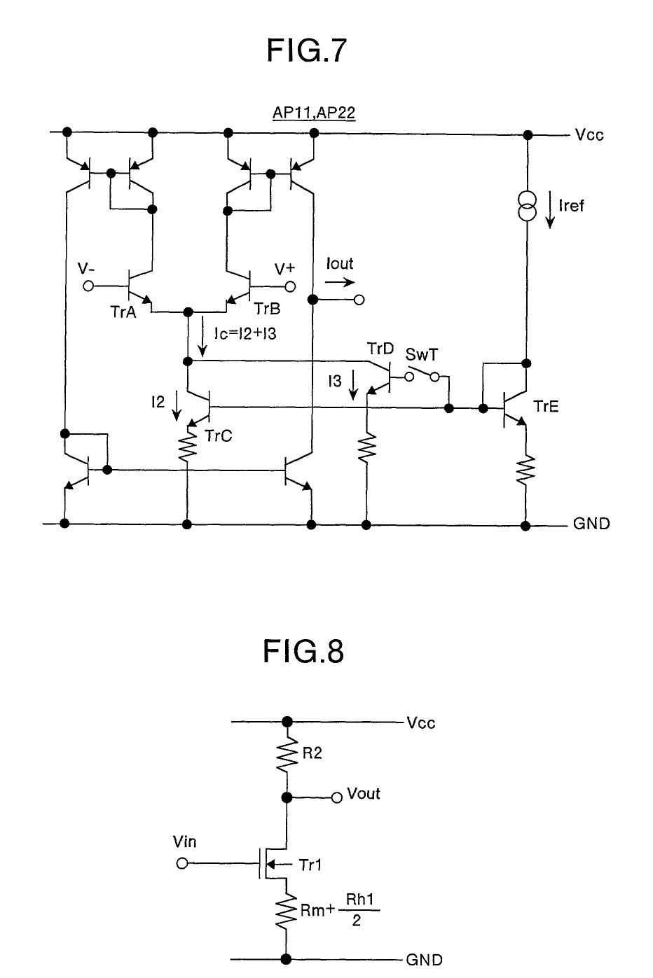

FIG. 7 shows a configuration example of the conductance amplifiers AP11 and AP22. In this FIG. 7, an input voltage V₊ and an input voltage V₋ are applied respectively to transistors TrA and TrB constituting a differential circuit. Transistors TrC, TrD are put between the common emitter junction of these transistors TrA and TrB and the ground in parallel. A constant voltage generated by a transistor TrE is applied to the base of the transistor TrC, and this constant voltage is applied to the base of the transistor TrD via a switch SwT. Therefore, with the switch SwT opened, an electric current of Ic=I2 flows out from the common emitter junction via the transistor TrC, and with the switch SwT closed, an electric current of Ic=I2+13 flows out from the common emitter junction via the transistors TrC and TrD.

Here, if it is assumed that the difference between the input voltage V₊ and the input voltage V₋ is Vid, the output voltage Iout of the transconductance amplifiers AP11 and AP22 is expressed as Iout=gm·Vid, using a conductance gm. The conductance gm is given by the following equation:

gm=Ic/Vt (1)

where in Vt: thermal voltage=kT/q (k denotes the Boltzman's constant, T denotes the absolute temperature, and q denotes an electric charge). Hence, these transconductance amplifiers AP11 and AP22 can change the conductance gm by opening or closing the switch SwT. The conductance amplifier shown in FIG. 2 is constructed by using a bipolar-type transistor, but it is also possible to constitute the conductance amplifier by using a CMOS-type transistor.

On the other hand, the current bias circuit in this second embodiment uses an N-channel MOS-type transistor Tr1 as the current source CS1, and a P-channel MOS-type transistor Tr2 as the current source CS2. Moreover, a resistance Rm is respectively put between the switch SW11 and the MR head H1, and between the switch SW12 and the MR head H1.

The transistor Tr1 increases a head bias current Is, with an increase of the output voltage Vo1′ of the low-pass filter LPF1 (which will be described later), and the transistor Tr2 provides feedback to the output voltage Vo2′ of the low-pass filter LPF2, so that the midpoint potential of the MR head H1 becomes the GND potential. Since the midpoint potential is maintained substantially to the GND potential, the transistor Tr1 constitutes an inverting amplifier as shown in FIG. 8. The gain A of this inverting amplifier is expressed as follows:

A=Vout/Vin=R2/{Rm+(Rh1/2)} (2)

wherein Vin is input voltage and Vout is output voltage.

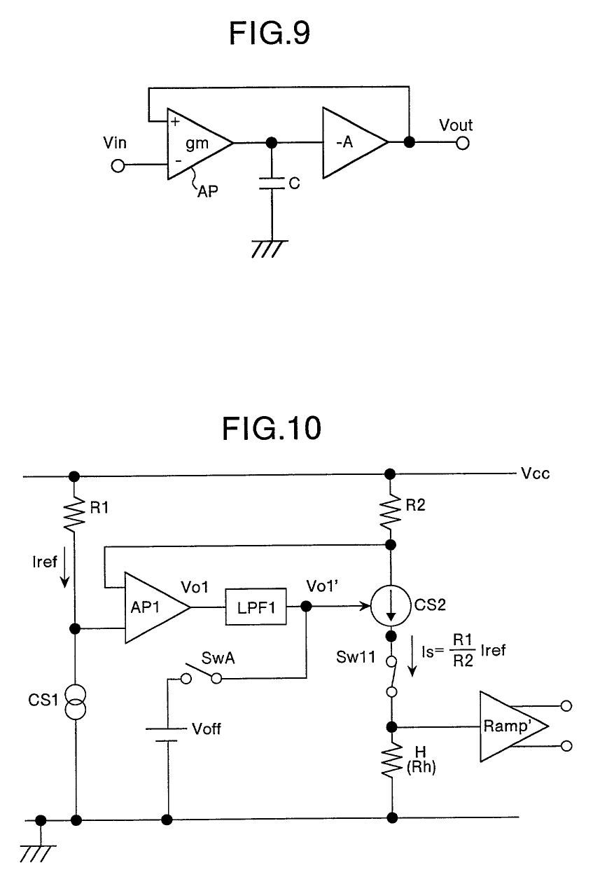

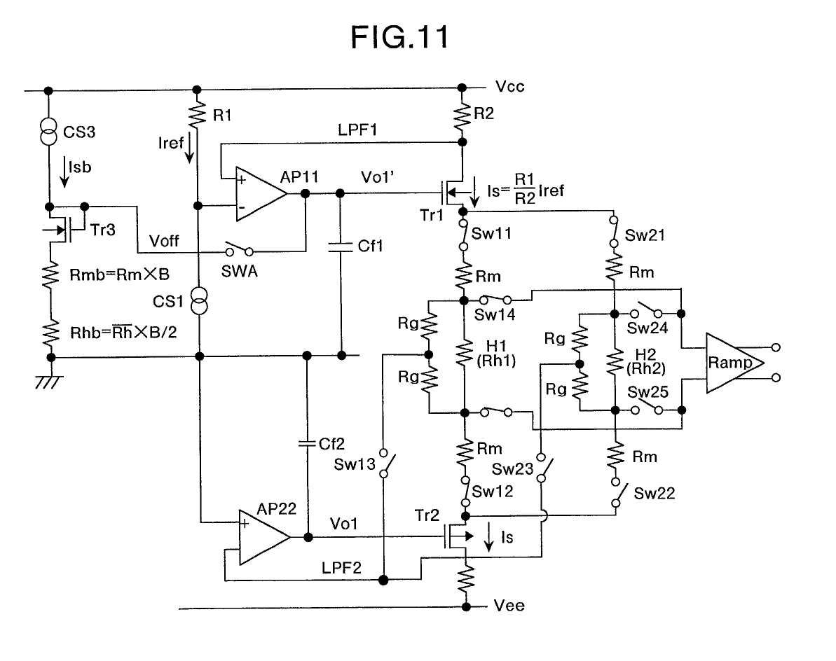

As shown in FIG. 9, when a circuit is constructed such that the output of the conductance amplifier AP, serving as a voltage-input current-output amplifier, is connected to the input of the inverting amplifier having the gain A (which has a function as a buffer amplifier when the gain A is 1), with the output of this inverting amplifier connected to one input of the conductance amplifier AP, and a filter capacitor C is put between the output of the inverting amplifier and the ground, then the relation between the input voltage Vin of the amplifier AP and the output voltage Vout of the inverting amplifier can be expressed as follows:

Vout={gm·A/(gm·A+jωC)}/Vin (3)

wherein ω is an angular frequency. That is to say, this circuit has a function as a low-pass filter having a time constant of C/(gm·A).

Therefore, a conductance amplifier AP11, the inverting amplifier including a transistor Tr1, and a filter capacitor Cf1 shown in FIG. 6 constitutes a low-pass filter. The time constant τ1 of this low-pass filter is expressed as follows:

τ1=Cf1/(gm1·A)=Cf1·{Rm+(Rh1/2)}/(R2·gm1) (4)

wherein gm1 is conductance of the amplifier AP11.

As is obvious from this equation (4), this low-pass filter changes the time constant, with a change in the conductance gm1 of the conductance amplifier Ap11. Therefore, if the conductance gm1 is changed so that the time constant decreases from the OFF point of the switch SwA shown in FIG. 4 for a predetermined period of time, the feedback time of the bias current Is can be shortened. Moreover, if the conductance gm1 is changed so that the time constant decreases from the ON point of the switch SwA shown in FIG. 5 for a predetermined period of time, the settling time of the bias current Is at the time of switching the heads can be shortened. As is obvious from the equation (4), if the resistance Rm is put in the flow channel of the bias current Is, an influence of the resistance Rh1 of the MR head H1 to the time constant can be suppressed.

The current bias circuit according to the first and second embodiments respectively uses a differential input type read amplifier Ramp, but it is also possible to use a Single-end input type read amplifier Ramp′, as shown in FIG. 10.

As is obvious from the comparison with FIG. 1, in this current bias circuit, the resistances Rg, the amplifier AP2, the low-pass filter LPF2, the switch Sw12 and the current source CS2 shown in FIG. 1 are not used. However, the same points as when the differential input type read amplifier Ramp is used are that the value of the bias current Is is determined by the output voltage Vo1′ of the low-pass filter LPF1 and that the above output voltage Vo1′ is maintained to the voltage Voff at the time of cutting the bias current Is. Though not shown, also when the Single-end input type read amplifier Ramp is used, it can be constructed such that the bias current Is is sent to either one of a plurality of MR heads. Moreover, instead of the amplifier AP1, the low-pass filter LPF1 and the current source CS2, the conductance amplifier Ap11, the capacitor Cf1 and the transistor Tr1 may be used.

The current bias circuit according to this third embodiment creates a voltage Voff having substantially the same value as that of the output voltage Vo1′ of the low-pass filter at the time when an appropriate bias current Is is flowing, by connecting in series a current source CS3 for generating an electric current Isb of 1/B (B is a constant) of a predetermined bias current Is, a MOS-type transistor Tr having a gate width of 1/B of the gate width of the transistor Tr1, a resistance Rmb having a value of resistance B times as large as the resistance Rm, and a resistance Rhb having a value of resistance B/2 times as large as the average resistance Rh of the MR heads. Therefore, if the switch SwA is turned ON at the time of cutting the bias current Is, the output of the conductance amplifier AP11 is maintained to the above voltage Voff.

As described above, in the transient at the time of resetting the bias current Is, and in the transient at the time of switching the heads, the time constant of the low-pass filters LPF1 and LPF2 is decreased, respectively, to thereby speed up the follow up speed of the output voltages Vo1′ and Vo2′. However, when the values of the voltages Voff and Vo1′ are largely different, the transient should be extended corresponding to the difference.

According to the third embodiment, since the voltage Voff is set to substantially the same value as that of the output voltage Vo1′ of the low-pass filter at the time when the appropriate bias current Is is flowing, it can be prevented that the current Is excessively flows immediately after the reset of the bias current Is. Also, by reducing the above transient (by setting the time constant shorter), the recovery period of the bias current can be further speeded up at the time of resetting the bias current Is and at the time of switching the heads. Also, there can be obtained an advantage that switching of an electric current is possible under the state that the bias current Is is cut. The technique according to this third embodiment is of course applicable to the current bias circuits shown in FIG. 1 and FIG. 2, which use the low-pass filters LPF1, LPF2 having the construction shown in FIG. 3.

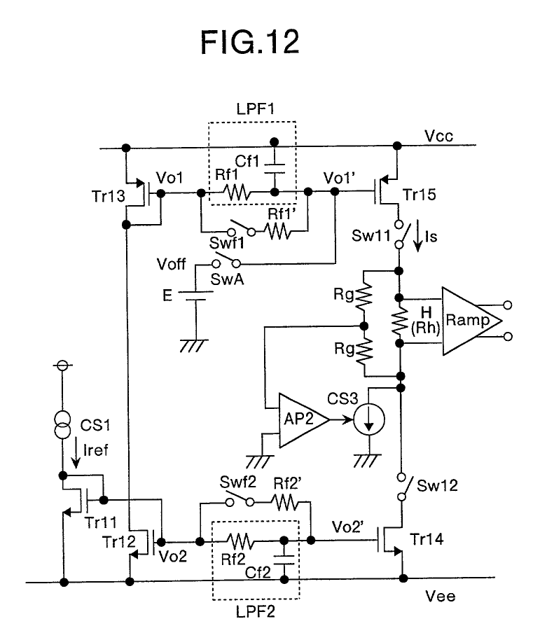

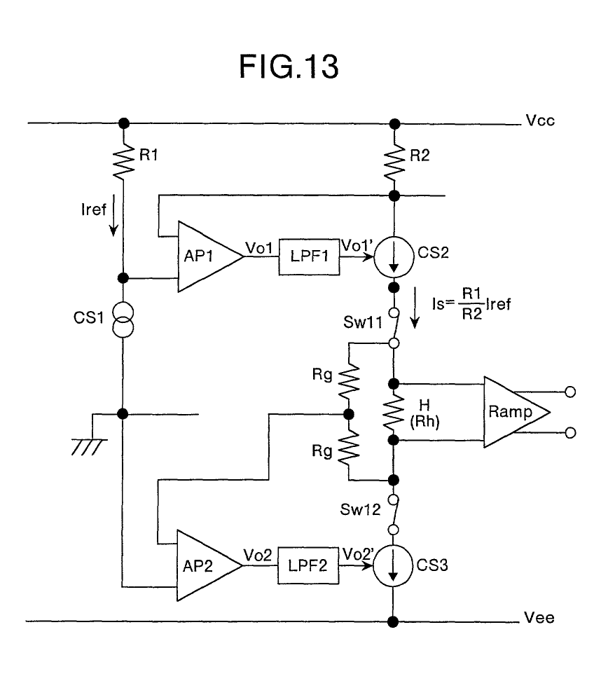

FIG. 12 shows a current bias circuit according to the fourth embodiment. This current bias circuit is constructed such that a current mirror circuit is formed of transistors Tr11, Tr12 and Tr13, and transistors Tr14 and Tr15, and an electric current Is corresponding to the reference current ref is biased to the MR head H.

That is to say, in this current bias circuit, an electric current corresponding to the reference current Iref is output from the transistors Tr13 and Tr12, and these voltages drive respectively the transistors Tr15 and Tr14 via the low-pass filters LPF1 and LPF2. In this current bias circuit, a current source CS3 is put between the junction of the MR head H and the transistor Tr14 and the ground, and by controlling this current source CS3 by the output of the amplifier AP2, the midpoint of the MR head H can be maintained to the ground potential.

The low-pass filters LPF1 and LPF2 have a construction corresponding to the construction shown in FIG. 3. That is, the low-pass filter LPF1 is constituted of a capacitor Cf1, a resistance Rf1 and a resistance Rf′1′ for changing the time constant, connected in parallel to the resistance Rf1 via a switch Swf1, and the low-pass filter LPF2 is constituted of a capacitor Cf2, a resistance Rf2 and a resistance Rf2′ for changing the time constant, connected in parallel to the resistance Rf2 via a switch Swf2.

With the current bias circuit according to this fourth embodiment, the MR head H is push-pull driven. In this current bias circuit, the output voltage Vo1′ of the low-pass filter LPF1 is set by an open loop. Needless to say, this current bias circuit is applicable to a case where the bias current is selectively sent to a plurality of MR heads.

As described above, according to the present invention, it is possible to prevent a large electric current from flowing temporarily to the MR head. Furthermore, it is possible to obtain a bias current having no influence of the noise. Moreover, the settling time of the bias current can be speeded up, by changing the time constant at the time of cutting the bias current, at the time of switching the MR heads, or at the time of switching the set value of the bias current.

Furthermore, influence of the value of resistance of the magnetic-signal detection head to the time constant of the low-pass filter can be suppressed. Moreover, when the cut bias current is reset to the original value, it is possible to prevent the bias current from flowing too much immediately after the reset. Also, it becomes possible to reduce the transient of the low-pass filter (to set the time constant shorter), to thereby speed up the recovery time of the bias current at the time of resetting the bias current or at the time of switching the heads. In addition, since the magnetic-signal detection head is push-pull driven by the control voltage generation unit, an output having no distortion can be obtained.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A current bias circuit used in a magnetic-signal detection head comprising:
a control voltage generation unit which generates a bias current control voltage, based on a reference current that regulates the bias current;
a bias current controlling unit which controls the bias current supplied to said magnetic-signal detection head based on the control voltage; and
a control voltage changing unit which changes a value of the control voltage, without changing the reference current.

2. The current bias circuit according to claim 1, wherein said control voltage generation unit includes a low-pass filter, wherein the control voltage is output via said low-pass filter, and
said control voltage changing unit includes a switching element which applies a predetermined voltage to the output of said low-pass filter.

3. The current bias circuit according to claim 2, wherein said low-pass filter comprises means for changing a time constant.

4. The current bias circuit according to claim 2, wherein said low-pass filter of said control voltage generation unit includes
a conductance amplifier which outputs a voltage obtained by multiplying the difference between the voltage corresponding to the reference current and the voltage corresponding to the bias current by the conductance;
an inverting amplifier, connected to said conductance amplifier, which passes the bias current through to said magnetic-signal detection head;
an inverting amplifier, connected to said conductance amplifier, which passes the bias current through to said magnetic-signal detection head; and
a filter capacitor connected to the output of said conductance amplifier, so that the predetermined voltage is applied to the output of said conductance amplifier by said switching element.

5. The current bias circuit according to claim 4, wherein said conductance amplifier includes a conductance changing unit which changes a time constant of said low-pass filter by changing a conductance.

6. The current bias circuit according to claim 4, wherein a plurality of resistances are connected in series to said magnetic-signal detection head.

7. The current bias circuit according to claim 2, wherein a value of the predetermined voltage applied by the switching element is set to a value of the output voltage of said low-pass filter in a state with the bias current flowing appropriately.

8. The current bias circuit according to claim 1, wherein said control voltage generation unit has a construction for push-pull driving said magnetic-signal detection head.
